(19) United States
(12) Patent Application Publication
(10) Pub. No.: US 2008/0283317 A1
(43) Pub. Date: Nov. 20, 2008

(54) Protective Housing for a Vehicle Battery

(75) Inventors: Michael WAGNER, Wiernsheim-Pinache (DE); Herbert KLAMSER, Korntal-Muenchingen (DE); Gerald HEKMANN, Ludwigsburg (DE); Franz-Rudolf WIERSCHEM, Weissach (DE); Thomas WUST, Sindelfingen (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F Porsche Aktiengesellschaft, Stuttgart (DE)

(21) Appl. No.: 12/121,372

(22) Filed: May 15, 2008

(30) Foreign Application Priority Data
May 18, 2007 (DE) 10 2007 023 391.6

(51) Int. Cl. B60R 16/04

(52) U.S. Cl. 180/68.5

(57) ABSTRACT

A protective housing for a vehicle battery, and a motor vehicle equipped therewith are provided. The protective housing has two transverse walls and two longitudinal walls, which together form a lateral enclosure for a battery receptacle chamber. A floor structure delimiting the battery receptacle chamber on the bottom is provided, which has at least two floor cross members fastened to the enclosure. A ceiling structure delimiting the battery receptacle chamber on top is provided, which has at least two ceiling cross members fastened to the enclosure.

### CROSS-REFERENCE TO RELATED APPLICATION

This application claims the priority of German Application No. 10 2007 023 391.6, filed May 18, 2007, the disclosure of which is expressly incorporated by reference herein.

This application is related to co-pending U.S. application Ser. No. ______, filed on even date herewith, and entitled “Protective Housing For A Vehicle Battery”.

### BACKGROUND AND SUMMARY OF THE INVENTION

The invention relates to a protective housing for a battery in a motor vehicle, as well as a motor vehicle equipped with such a protective housing.

A protective housing for a battery in a motor vehicle is known from EP 1 182 093 B1, which housing has two transverse walls and two longitudinal walls that together form a lateral enclosure for a battery receptacle chamber. The protective housing is fastened to a longitudinal girder of the motor vehicle in an installation chamber of the vehicle in the installed state. The known protective housing is the installation chamber around the engine compartment in which the engine of the vehicle is located. To reduce the danger of damage to the battery in the event of a collision, a platform on which the protective housing is situated, and via which the protective housing is fastened to the longitudinal girder, is provided with two ramps which contribute to allowing the platform having the protective housing and the battery situated therein to slide off on two vehicle-side obstructions.

The present invention is concerned with the problem of providing an improved embodiment for a protective housing of the above-mentioned type, which is distinguished in particular by improved collision protection.

This problem is solved according to the invention by a protective housing for a vehicle battery, in particular in a motor vehicle, having two transverse walls and two longitudinal walls, which together form a lateral enclosure for a battery receptacle chamber. A floor structure, delimiting the battery receptacle chamber on the bottom, has at least two floor cross members fastened to the enclosure. A ceiling structure, delimiting the battery receptacle chamber on top, has at least two ceiling cross members fastened to the enclosure. Advantageous embodiments of the invention are described and claimed herein.

The invention is based on the general idea of stiffening the enclosure of the protective housing through a floor structure and a ceiling structure. A more stable cage may thus be provided for the battery receptacle chamber, which also deforms only relatively slightly in case of a crash, and by which damage to the battery received therein may be avoided or at least particularly minimized.

The fastening and/or support of the enclosure to two longitudinal girders of the vehicle, between which an installation chamber for housing the protective housing is implemented, is especially advantageous. In this way, the protective housing may be fixed to the vehicle with increased stability, which favors the absorption of forces in case of a crash.

In improved embodiments, the ceiling structure and/or the floor structure may be stiffened using diagonal struts, which are supported on the cross members of the particular structure. Longitudinal struts may, additionally or alternatively, be provided to additionally stiffen the particular structure.

To improve the support of the enclosure in the vehicle, the protective housing may additionally be supported on a vehicle cross member, which cross member connects the two longitudinal girders of the vehicle to one another.

It is obvious that the features cited above and to be explained hereafter are usable not only in the particular specified combination, but rather also in other combinations or alone without leaving the scope of the present invention.

Preferred exemplary embodiments of the invention are illustrated in the drawings and explained in greater detail in the following description, identical reference signs relating to identical or similar or functionally identical components.

### BRIEF DESCRIPTION OF THE DRAWINGS

FIG. 1 shows a greatly simplified schematic top view of a vehicle (only partially shown) in the area of a protective housing;

FIG. 2 shows a top view of a ceiling structure of the protective housing; and

FIG. 3 shows a top view of a floor structure of the protective housing.

### DETAILED DESCRIPTION OF THE DRAWINGS

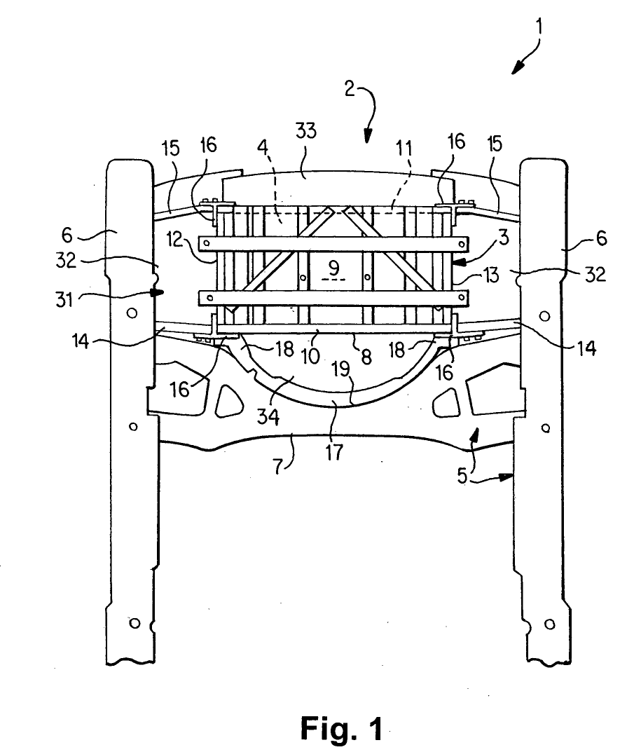

According to FIG. 1, an installation chamber 2 for receiving a protective housing 3 for a battery 4 may be implemented in a motor vehicle 1 (only partially shown here). The vehicle 1 may preferably be a hybrid vehicle, which has at least one electric motor for driving the vehicle 1 in addition to an internal combustion engine. The installation chamber 2 may be situated in a front chamber or, preferably, in a rear chamber of the vehicle 1. A rear end section of a shell structure 5 of the vehicle 1 is shown in FIG. 1. The battery 4 may be implemented as a traction battery, in particular in a hybrid vehicle 1, and thus have comparatively large dimensions.

The vehicle 1 and/or its shell 5 has two longitudinal girders 6 in the area shown, which extend essentially parallel to a vehicle longitudinal direction. The installation chamber 2 is implemented between the two vehicle longitudinal girders 6. The protective housing 3 is preferably situated essentially centrally between the two vehicle longitudinal girders 6. Furthermore, the installation chamber 2 is delimited here by a vehicle cross member 7, which connects the two vehicle longitudinal girders 6, i.e., is fastened thereto. The vehicle cross member 7 extends essentially parallel to a vehicle transverse direction, which is perpendicular to the vehicle longitudinal direction.

The protective housing 3 has an enclosure 8, which laterally encloses a chamber 9 for receiving the battery 4. The enclosure 8 is assembled from two transverse walls 10, 11 and two longitudinal walls 12, 13. The cited walls 10 through 13 are preferably each implemented as separate components, so that the enclosure 8 is assembled using these individual wall components 10 through 13. With the positioning of the protective housing 3 in the rear of the vehicle 1 shown here, the transverse walls 10, 11 are thus a front transverse wall 10 or front wall 10 and a rear transverse wall 11 or rear wall 11. The transverse walls 10, 11 extend parallel to the vehicle transverse direction. In contrast thereto, the longitudinal walls 12, 13 extend parallel to the vehicle longitudinal direction and form side walls 12, 13 of the enclosure 8. The walls 10 through 13 are implemented to be resistant to bending and may be produced, for example, as extruded profiles, in particular made of aluminum, and with or without chambers. The individual walls 10, 13 may be fastened to one another in a suitable manner in the corner areas of the protective housing 3. For example, the walls 10, 13 are welded to one another. The structure is relatively simple to reinforce by inserted stiffening profiles (e.g., made of steel) in the chambers of the extruded profile.

The enclosure 8 is fastened to both longitudinal girders 6. Here, the enclosure 8 is attached to the longitudinal girders 6 with the aid of front support elements 14 and rear support elements 15. The support elements 14, 15 are fastened via angle elements 16 to the enclosure 8, for example, by screwing and/or welding. For example, the angle elements 16 are welded to the enclosure 8 and screwed onto the support elements 14, 15. The support elements 14, 15 are fastened in a suitable manner to the longitudinal girders 6, for example, by screws and/or welds. In the example shown, the enclosure 8 is attached to the two longitudinal girders 6 in that the front transverse wall 10 is fastened to both longitudinal girders 6 via the two front support elements 14 and, in addition, the rear transverse wall 11 is fastened to both longitudinal girders 6 via the two rear support elements 15.

In addition, in the embodiment shown here, the protective housing 3 is supported on the cross member 7. For this purpose, a support girder 17 is provided, which has a curved form in the view shown. The support girder 17 is fastened at its ends 18 to the enclosure 8, for example, via the angle elements 16. Between its ends 18, the support girder 17 may come to rest on the cross member 7. The cross member 7 expediently has a concave contour 19 on its side facing toward the installation chamber 2, along which the contact between support girder 17 and cross member 7 may occur. Optionally, the support girder 17 may be fastened to the cross member 7, for example, by spot welds or screws.

For the intensive stiffening of the enclosure 8 and/or the protective housing 3, it is provided with a ceiling structure 20 on top and a floor structure 21 on the bottom. The ceiling structure 20 delimits the battery receptacle chamber 9 on top, while the floor structure 21 delimits the battery receptacle chamber 9 on the bottom. The ceiling structure 20 and the floor structure 21 are each fastened to the enclosure 8, by which the protective housing 3 forms a cage enclosing the battery receptacle chamber 9 on all sides, which has a comparatively high dimensional stability and offers effective protection of the battery 4 housed therein from damage in case of a crash.

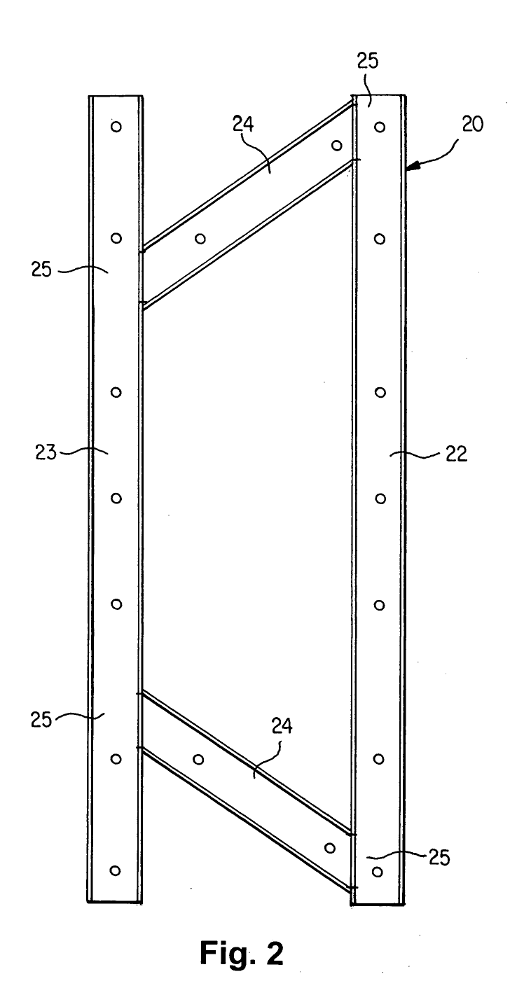

FIG. 2 shows a preferred embodiment for a ceiling structure 20 of this type. The ceiling structure 20 has two ceiling cross members 22, 23, namely a front ceiling cross member 22 and a rear ceiling cross member 23 according to the installation situation shown here. The two ceiling cross members 22, 23 are both fastened to the enclosure 8. For example, the ceiling cross members 22, 23 are screwed to the longitudinal walls 12, 13 via angle parts (not shown here). The ceiling structure 20 shown in FIG. 2 additionally has two ceiling diagonal struts 24, which run inclined in relation to the vehicle longitudinal direction and in relation to the vehicle transverse direction, for example, at approximately 45°. In this way, fastening points 25 or node points at which the ceiling diagonal struts 24 are fastened to one ceiling cross member 22 and/or to the other ceiling cross member 23 have different distances from one another. In the example shown, the fastening points 25 at which the ceiling diagonal struts 24 are attached to the rear ceiling cross member 23 are positioned closer to one another than the fastening points 25 at which the ceiling diagonal struts 24 are attached to the front ceiling cross member 22. Through this construction, a force which acts on the rear ceiling cross member 23 in a rear crash may be transmitted via the ceiling diagonal struts 24 to the front ceiling cross member 22 and at least partially deflected into a traction force, which the front ceiling cross member 22 may absorb without further measures. In the preferred example shown in FIG. 2, the ceiling cross members 22, 23 and the ceiling diagonal struts 24 are formed as U-profile rods, through which they have increased flexural strength.

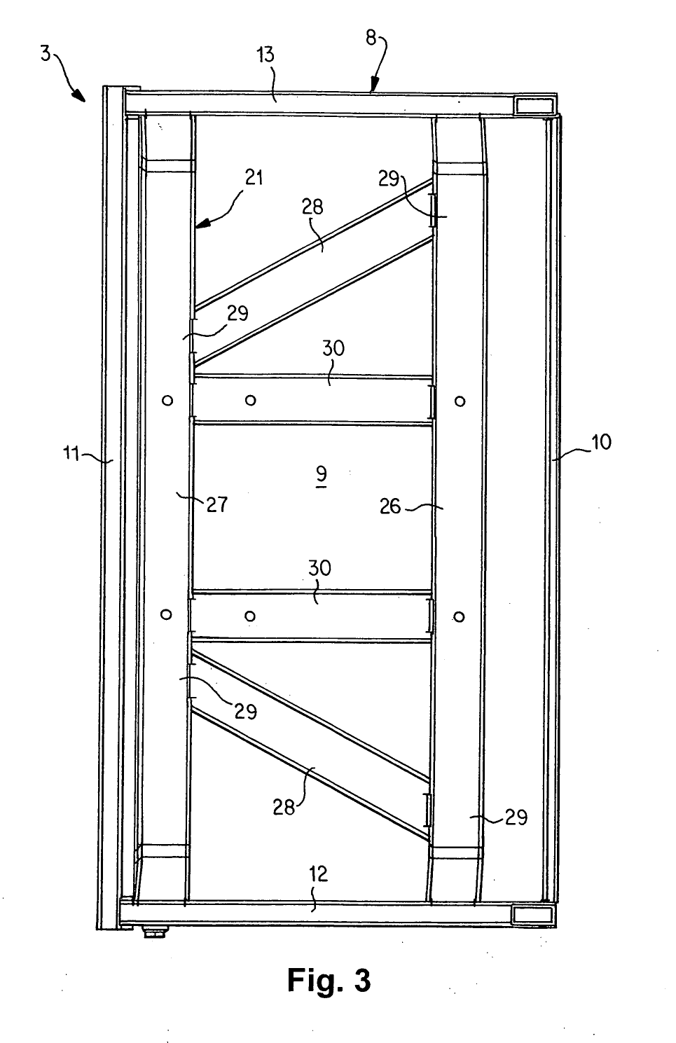

FIG. 3 shows the protective housing 3 in a top view with the ceiling structure 20 left off, through which the floor structure 21 may be seen better. According to the preferred embodiment shown in FIG. 3, the floor structure 21 has two floor cross members 26, 27, namely a front floor cross member 26 and a rear floor cross member 27 corresponding to the preferred installation situation here. The floor cross members 26, 27 are fastened to the enclosure 8, preferably to the longitudinal walls 12, 13. For example, the floor cross members 26, 27 may have bent-over ends for this purpose, which are then welded or screwed to the longitudinal walls 12, 13 directly or via corresponding angle elements.

In the preferred embodiment shown here, the floor structure 21 additionally has two floor diagonal struts 28. These are each fastened on one side to the rear floor cross member 27 and on the other side to the front floor cross member 26. The floor diagonal struts 28 are also oriented inclined in relation to the vehicle longitudinal direction and in relation to the vehicle transverse direction, also essentially by approximately 45°. Fastening points or connection nodes 29, via which the floor diagonal struts 28 are fastened to the floor cross members 26, 27, are also provided at different distances to one another on the front floor cross member 26 and on the rear floor cross member 27.

In the preferred embodiment shown here, the fastening points 29, via which the floor diagonal struts 28 are supported on the rear floor cross member 27, are positioned closer to one another than the fastening points 29, via which the floor diagonal struts 28 are fastened to the front floor cross member 26. Crash forces applied from the rear may also be transmitted from the rear floor cross member 27 to the front floor cross member 26 and partially converted into traction forces through this construction. To stiffen the floor structure 21 further, it may optionally be provided with at least one floor longitudinal strut 30. Two floor longitudinal struts 30 of this type are provided in the example shown. Each of the floor longitudinal struts 30 is supported on one side on one floor cross member 26 and on the other side on the other floor cross member 27. The floor longitudinal struts 30 are preferably situated between the floor diagonal struts 28. A direct force transmission may be implemented between the floor cross members 26, 27 via the floor longitudinal struts 30. It is clear that fundamentally the ceiling structure 20 may also be equipped with at least one ceiling longitudinal strut.

In the floor structure 21 shown here, the floor cross members 26, 27 and the floor diagonal struts 28, as well as the floor longitudinal struts 30, are preferably designed as U-profile struts, which are distinguished by increased flexural strength.

In addition, the vehicle 1 from FIG. 1 may have a floor plate 31, which delimits the installation chamber 2 on the bottom. In particular, this floor plate 31 also extends outside the floor structure 21. The floor plate 31, which may be formed in particular by a sheet metal component, projects laterally beyond the protective housing 3 and is connected via side sections 32 to the vehicle longitudinal girders 6. A rear longitudinal section 33 of the floor plate 31 may also project to the rear beyond the protective housing 3. A front longitudinal section 34 connects the floor plate 31 to the support girder 17 and/or to the vehicle cross member 7. In addition, the protective housing 3 may be fixedly connected to the floor plate 31, which additionally reinforces the fixing of the protective housing 3 in the installation chamber 2.

In case of a crash, the rear area of the vehicle 1 is impinged by longitudinal forces oriented forward. These forces may be absorbed by the rear wall 11, by the rear floor cross member 27, and by the rear ceiling cross member 23 and partially transmitted via the rear support elements 15 into the vehicle longitudinal girders 6. Moreover, the longitudinal forces are transmitted via the longitudinal walls 12, 13, via the floor diagonal struts 28 and the ceiling diagonal struts 24 to the front wall 10, to the front floor cross member 26 and the front ceiling cross member 22. From there, the vehicle longitudinal forces are partially transmitted further via the front support elements 14 to the vehicle longitudinal girders 6 and also via the support girder 17 to the vehicle cross member 7. The vehicle cross member 7, in turn, transmits the forces into the vehicle longitudinal girders 6. In the most favorable case, the longitudinal forces occurring in case of a crash are conducted around the battery receptacle chamber 9, without intrusion into the battery receptacle chamber 9 in order to prevent damage to the battery 4.

The foregoing disclosure has been set forth merely to illustrate one or more embodiments of the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A protective housing for a battery of a vehicle, comprising:
a lateral enclosure in which is formed a battery receptacle chamber, the lateral enclosure comprising two transverse walls and two longitudinal walls;
a floor structure which delimits a bottom of the battery receptacle chamber, the floor structure comprising at least two floor cross members fastened to the lateral enclosure; and
a ceiling structure delimiting a top of the battery receptacle chamber, the ceiling structure comprising at least two cross members fastened to the lateral enclosure.

2. The protective housing according to claim 1, further comprising at least one of:
(a) two ceiling diagonal struts of the ceiling structure, which are fastened at one end to one ceiling cross member and at the other end to the other ceiling cross member, fastening points between the ceiling diagonal struts and the associated ceiling cross member having a greater distance from one another on one ceiling cross member than on the other ceiling cross member; and
(b) two floor diagonal struts of the floor structure, which are fastened at one end to one floor cross member and at the other end to the other floor cross member, fastening points between the floor diagonal struts and the associated floor cross member having a greater distance from one another on one floor cross member than on the other floor cross member.

3. The protective housing according to claim 2, further comprising at least one of:
(a) at least one ceiling longitudinal strut of the ceiling structure, which is fastened at one end to one ceiling cross member and at the other end to the other ceiling cross member; and
(b) at least one floor longitudinal strut of the floor structure, which is fastened at one end to one floor cross member and at the other end to the other floor cross member.

4. The protective housing according claim 2, wherein at least one of:
the at least one ceiling longitudinal strut being situated between the two ceiling diagonal struts; and
the at least one floor longitudinal strut being situated between the two floor longitudinal struts.

5. The protective housing according claim 3, wherein at least one of:
the at least one ceiling longitudinal strut being situated between the two ceiling diagonal struts; and
the at least one floor longitudinal strut being situated between the two floor longitudinal struts.

6. The protective housing according to claim 3, further wherein at least one of:
(a) the longitudinal walls and/or at least one of the transverse walls are designed as an extruded profile, and
(b) the cross members of the ceiling structure and the floor structure are designed as U-profile rods, and
(c) the diagonal struts of the ceiling structure and the floor structure are designed as U-profile rods, and
(d) the at least one longitudinal strut of the ceiling structure and the floor structure are designed as a U-profile rod.

7. The protective housing according to claim 5, further wherein at least one of:
(a) the longitudinal walls and/or at least one of the transverse walls are designed as an extruded profile, and
(b) the cross members of the ceiling structure and the floor structure are designed as U-profile rods, and
(c) the diagonal struts of the ceiling structure and the floor structure are designed as U-profile rods, and
(d) the at least one longitudinal strut of the ceiling structure and the floor structure are designed as a U-profile rod.

8. The protective housing according to claim 1, wherein the two transverse walls and the two longitudinal walls are each formed by separate components, which are assembled to form the lateral enclosure.

9. A motor vehicle having a battery, comprising:
two vehicle longitudinal girders, between which an installation chamber is formed;
a protective housing for the battery situated in the installation chamber, the protective housing comprising:
a lateral enclosure in which is formed a battery receptacle chamber, the lateral enclosure comprising two transverse walls and two longitudinal walls;
a floor structure which delimits a bottom of the battery receptacle chamber, the floor structure comprising at least two floor cross members fastened to the lateral enclosure;
a ceiling structure delimiting a top of the battery receptacle chamber, the ceiling structure comprising at least two cross members fastened to the lateral enclosure; and
wherein the enclosure of the protective housing is fastened to both vehicle longitudinal girders.

10. The vehicle according to claim 9, further comprising a vehicle cross member connecting the two vehicle longitudinal girders, wherein the protective housing is supported on the vehicle cross member.

11. The vehicle according to claim 10, further comprising a curved support girder fastened at ends thereof to the lateral enclosure, the curved support girder supporting the protective housing on the vehicle cross member.

12. The vehicle according to claim 9, wherein the lateral enclosure is fastened to both vehicle longitudinal girders in that the front transverse wall is fastened via two front support elements to the two vehicle longitudinal girders and the rear transverse wall is fastened via two rear support elements to the two vehicle longitudinal girders.

13. The vehicle according to claim 10, wherein the lateral enclosure is fastened to both vehicle longitudinal girders in that the front transverse wall is fastened via two front support elements to the two vehicle longitudinal girders and the rear transverse wall is fastened via two rear support elements to the two vehicle longitudinal girders.

14. The vehicle according to claim 11, wherein the lateral enclosure is fastened to both vehicle longitudinal girders in that the front transverse wall is fastened via two front support elements to the two vehicle longitudinal girders and the rear transverse wall is fastened via two rear support elements to the two vehicle longitudinal girders.

15. The vehicle according to claim 9, wherein the installation chamber is located in a rear of the vehicle.

16. The vehicle according to claim 10, wherein the installation chamber is located in a rear of the vehicle.

17. The vehicle according to claim 11, wherein the installation chamber is located in a rear of the vehicle.

18. The vehicle according to claim 12, wherein the installation chamber is located in a rear of the vehicle.
